(19) United States
(12) Patent Application Publication
(10) Pub. No.: US 2020/0184908 A1
(43) Pub. Date: Jun. 11, 2020

(54) LIQUID CRYSTAL DISPLAY DEVICE

(71) Applicant: Panasonic Liquid Crystal Display Co., Ltd., Hyogo (JP)

(72) Inventor: Takenobu NISHIGUCHI, Nara (JP)

(21) Appl. No.: 16/212,241

(22) Filed: Dec. 6, 2018

(51) Int. Cl. G09G 3/34; G09G 3/36

(52) U.S. Cl. CPC G09G 3/3406; G09G 2320/0653; G09G 2300/023; G09G 3/3677

(57) ABSTRACT

A liquid crystal display (LCD) device includes a first and second LCD panels having a plurality of first and second gate lines. A backlight is on a side of the first LCD panel such that the first LCD panel is adjacent the backlight and between the second LCD panel and the backlight. The backlight includes a plurality of rows of light sources. A driving circuit supplies a drive signal to the light sources. A controller scans the plurality of first and second gate lines. The controller controls the driving circuit to illuminate a first row of the light sources after the scan of a first set of the plurality of first or second gate lines. The controller controls the driving circuit to not illuminate the first row of the light sources until the scan of a second set of the plurality of first or second gate lines is completed.

### FIELD

This disclosure relates generally to an electronic display device. More specifically, the disclosure relates to an electronic display device such as, but not limited to, a liquid crystal display (LCD) device and driving methods for an LCD device including a plurality of LCD panels.

### BACKGROUND

A liquid crystal display (LCD) device is an electronic display that is widely used as a display for electronic devices such as, but not limited to, computers, televisions, cellular phones, and the like. An LCD device generally includes a thin film transistor (TFT) substrate and a color filter (CF) substrate. A liquid crystal layer is disposed between the TFT substrate and the CF substrate.

### SUMMARY

This disclosure relates generally to an electronic display device. More specifically, the disclosure relates to an electronic display device such as, but not limited to, a liquid crystal display (LCD) device and driving methods for an LCD device including a plurality of LCD panels.

In an embodiment, an electronic display device is an LCD device.

In an embodiment, the LCD device is an in-plane switching (IPS) mode LCD device.

In an embodiment, the electronic display device can be included as a display for an electronic device such as, but not limited to, a display for a laptop computer.

An LCD device is disclosed. The LCD device includes a first LCD panel including a plurality of first gate lines and a second LCD panel including a plurality of second gate lines. A backlight is arranged on a side of the first LCD panel such that the first LCD panel is adjacent the backlight and between the second LCD panel and the backlight. The backlight includes a plurality of rows of light sources. A driving circuit is configured to supply a drive signal to the plurality of rows of light sources. A controller is configured to scan the plurality of first gate lines and scan the plurality of second gate lines. The controller is further configured to control the driving circuit to illuminate a first row of the plurality of rows of light sources after the scan of a first set of the plurality of first gate lines or after the scan of a first set of the plurality of second gate lines. The controller is configured to control the driving circuit to not illuminate the first row of the plurality of rows of light sources until the scan of a second set of the plurality of first gate lines is completed or the scan of a second set of the plurality of second gate lines is completed.

A method of illuminating an LCD device including a first LCD panel, a second LCD panel, and a backlight is also disclosed. The method includes scanning, with a controller, a plurality of first gate lines that correspond to the first LCD panel. The controller scans a plurality of second gate lines that correspond to the second LCD panel. A drive signal is enabled to a first row of a plurality of rows of light sources of the backlight before completing scanning of a first set of the plurality of first gate lines or in response to completing scanning of a first set of the plurality of second gate lines. The drive signal is disabled to the first row of the plurality of rows of light sources of the backlight before completing scanning of a second set of the plurality of first gate lines or completing scanning of a second set of the plurality of second gate lines.

A scanning backlight system for an LCD device is also disclosed. The LCD device includes a first LCD panel including a plurality of first gate lines and a second LCD panel including a plurality of second gate lines. A backlight is arranged on a side of the first LCD panel such that the first LCD panel is adjacent the backlight and between the second LCD panel and the backlight. The backlight includes a plurality of rows of light sources. The scanning backlight system includes a driving circuit configured to supply a drive signal to the plurality of rows of light sources and a controller. The controller is configured to scan the plurality of first gate lines and scan the plurality of second gate lines. The controller is configured to control the driving circuit to illuminate a first row of the plurality of rows of light sources after the scan of a first set of the plurality of first gate lines or after the scan of a first set of the second plurality of second gate lines. The controller is further configured to control the driving circuit to not illuminate the first row of the plurality of rows of light sources until the scan of a second set of the plurality of first gate lines is completed or the scan of a second set of the second plurality of second gate lines is completed.

### BRIEF DESCRIPTION OF THE DRAWINGS

References are made to the accompanying drawings that form a part of this disclosure, and which illustrate embodiments in which the systems and methods described in this specification can be practiced.

FIG. 1 is a schematic diagram of a liquid crystal display device, according to an embodiment.

FIG. 2 is a schematic diagram of a liquid crystal display device including a plurality of the liquid crystal display panels of FIG. 1, according to an embodiment.

FIG. 3 is a flowchart of a method for controlling a backlight in the liquid crystal display device including a plurality of liquid crystal display panels of FIG. 2, according to an embodiment.

FIG. 4 shows timing charts of the method of FIG. 3 for controlling a backlight in the liquid crystal display device of FIG. 2, according to an embodiment.

FIG. 5 shows timing charts of the method of FIG. 3 for controlling a backlight in the liquid crystal display device of FIG. 2, according to an embodiment.

Like reference numbers represent like parts throughout.

### DETAILED DESCRIPTION

This disclosure relates generally to an electronic display device. More specifically, the disclosure relates to an electronic display device such as, but not limited to, a liquid crystal display (LCD) device and driving methods for an LCD device including a plurality of LCD panels.

Dual panel LCD devices generally include a backlight that is continuously illuminated. As a result, the panels composing the LCD devices can absorb a significant amount of light, which can result in a large amount of heat absorption.

Embodiments of this disclosure are directed to driving methods for a multi-panel LCD device (e.g., a dual panel LCD device or the like) which selectively illuminate the backlight. Because the backlight is selectively illuminated instead of continuously illuminated, heat absorption can be reduced relative to prior multi-panel LCD devices. In an embodiment, selectively illuminating the backlight can lead to an energy consumption of the multi-panel LCD device being reduced relative to prior devices. Reducing an on-period of the backlight, however, can result in a decreased brightness of the display of the multi-panel LCD device. The driving methods in this disclosure balance a brightness of the display relative to the heat and energy savings.

Embodiments can be in the form of an LCD device. It will be appreciated that the principles described in this Specification can be applied to other types of electronic display devices. For example, such electronic display devices as Micro Electro Mechanical Systems (MEMS) or the like.

An electronic display device can be constructed of a plurality of LCD panels. In an embodiment, the electronic display device includes two LCD panels. A first LCD panel is disposed relatively closest to a light source. A second LCD panel is disposed relatively further from the light source than the first LCD panel. That is, the second LCD panel is disposed relatively closest to the viewer. In operation, the light source (e.g., a backlight) can be illuminated to provide light traveling through the first LCD panel and then the second LCD panel, in that order, to display an image for the viewer. It is to be appreciated that the plurality of LCD panels can include a number of panels greater than two.

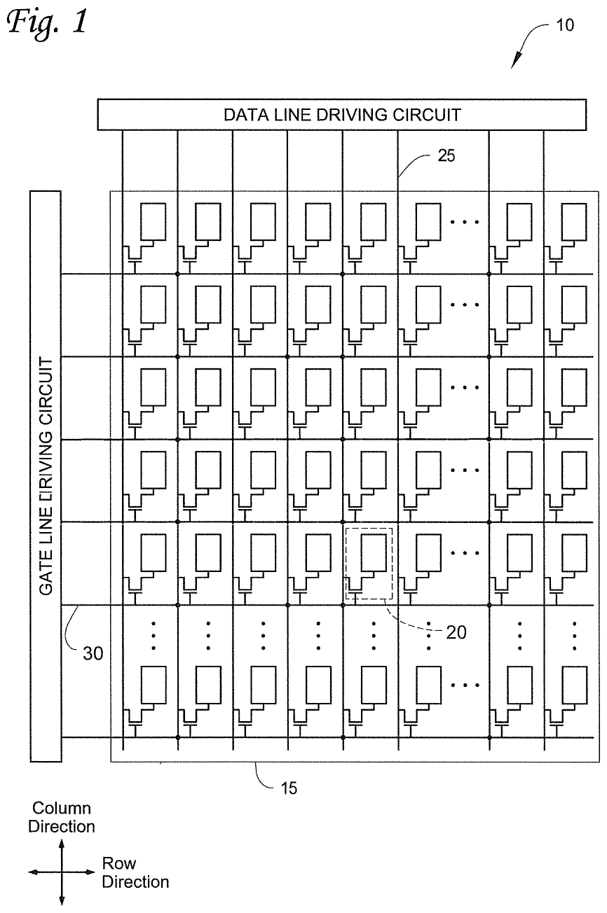

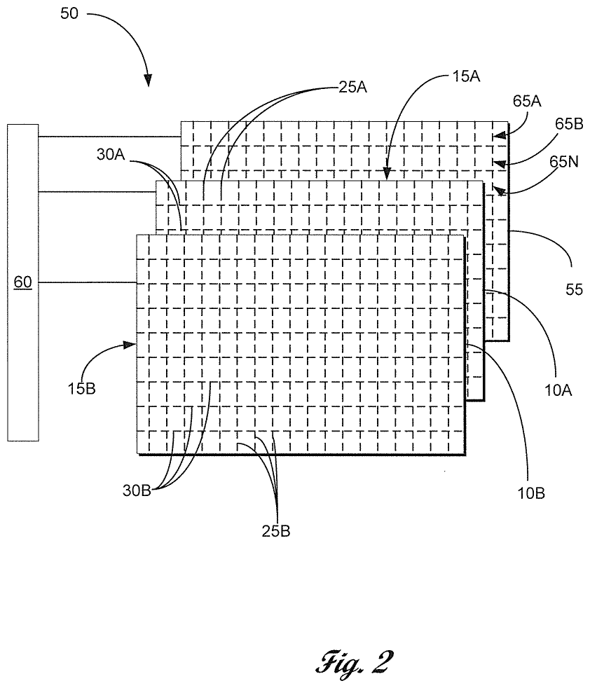

FIG. 1 is a schematic diagram of an LCD device, according to an embodiment. The LCD device includes LCD panel 10 that displays an image, a driving circuit (data line driving circuit, gate line driving circuit) that drives LCD panel 10, a control circuit (not illustrated in FIG. 1, see controller 60 in FIG. 2) that controls the driving circuit, and a backlight (not illustrated in FIG. 1, see backlight 55 in FIG. 2) that irradiates LCD panel 10 with light from a rear surface side.

In display region 15 of the LCD panel 10, pixels 20 (each of which is surrounded by two adjacent data lines 25 and two adjacent gate lines 30) are arrayed into a matrix shape in row and column directions. It is assumed that the column direction is a direction in which data line 25 extends, and that the row direction is a direction in which the gate line 30 extends.

The LCD device can display an image by controlling each pixel 15 to filter light in a specific manner. For example, the pixels 15 may be configured to filter a specific color of light or filter light without filtering a specific color of light (e.g., for brightness). In an embodiment, the pixels 15 can be configured to filter red, green, or blue light. For example, red, blue, and green pixels 15 may repeat in a row such that each set of adjacent three pixels includes one (red) pixel 15 that filters red light, one (green) pixel 15 that filters green light, and one (blue) pixel 15 that filters blue light. For example, a red pixel 15 may provide the red light for a pixel in the displayed image. In such an embodiment, the light of each pixel in the image displayed by the LCD device is formed by the combined red light, green light, and blue light provided by a respective red pixel 15, green pixel 15, and blue pixel 15. In an embodiment, the pixels 15 may filter two or more colors. In an embodiment, one or more of the pixels 15 may provide brightness. In an embodiment, the LCD device may include multiple LCD panels 10.

FIG. 2 is a schematic diagram of an LCD device 50 including a plurality of LCD panels 10, according to an embodiment. The plurality of LCD panels 10 includes a first LCD panel 10A and a second LCD panel 10B. It is to be appreciated that in an embodiment the LCD device 50 can include more than two LCD panels 10. In the LCD device 50, the first LCD panel 10A and the second LCD panel 10B are laminated with a backlight 55. When laminated, the second LCD panel 10B is relatively closer to the viewer than the first LCD panel 10A. Light transmitted from the backlight 55 is transmitted, in order, through the pixels of the first LCD panel 10A and then the pixels of the second LCD panel 10B.

The first LCD panel 10A and the second LCD panel 10B have the same basic structure in accordance with the LCD panel 10 of FIG. 1.

The first LCD panel 10A includes a display region 15A having a plurality of rows of data lines 25A and a plurality of rows of gate lines 30A. A controller 60 is electrically connected to the gate line driving circuit (see FIG. 1, not shown in FIG. 2 for simplicity of the figure) and to the data line driving circuit (see FIG. 1, not shown in FIG. 2 for simplicity of the figure) of the first LCD panel 10A.

The second LCD panel 10B includes a display region 15B having a plurality of rows of data lines 25B and a plurality of rows of gate lines 30B. The controller 60 is electrically connected to the gate line driving circuit (see FIG. 1, not shown in FIG. 2 for simplicity of the figure) and to the data line driving circuit (see FIG. 1, not shown in FIG. 2 for simplicity of the figure) of the second LCD panel 10B.

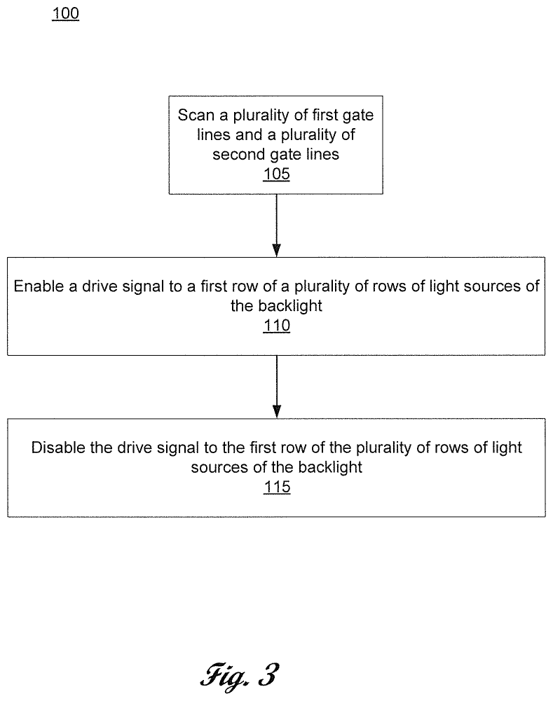

The backlight 55 includes a plurality of rows 65 of light sources. Each row 65A-65N of the plurality of rows 65 of light sources is separately illuminable. That is, each of the rows 65A-65N of the plurality of rows 65 of light sources 65 can be selectively enabled or selectively disabled according to the driving methods described in accordance with FIG. 3 below. In an embodiment, a row of the plurality of rows 65 of light sources can include a set of rows, not just a single row.

In an embodiment, the LCD device 50 can be a curved LCD device (e.g., by imparting a curvature to the laminated structure including the LCD panels 10A, 10B and the backlight 55).

FIG. 3 is a flowchart of a method 100 for controlling the backlight (e.g., the backlight 55 in FIG. 2), according to an embodiment.

At 105 a controller (e.g., the controller 60 in FIG. 2) scans a plurality of first gate lines (e.g., the plurality of gate lines 30A in FIG. 2 corresponding to the first LCD panel 10A) and a plurality of second gate lines (e.g., the plurality of gate lines 30B in FIG. 2 corresponding to the second LCD panel 10B).

In an embodiment, ordering of the scanning of the plurality of first gate lines 30A and the scanning of the plurality of second gate lines 30B can vary. In an embodiment, the controller 60 can scan the plurality of first gate lines 30A before beginning the scanning of the plurality of second gate lines 30B. For example, the controller 60 can begin scanning a first set (e.g., a subset) of the plurality of first gate lines 30A prior to scanning the plurality of second gate lines 30B. In an embodiment, the controller 60 can wait until the first set of the plurality of first gate lines 30A is completed or the controller 60 can begin scanning the plurality of second gate lines 30B while the plurality of first gate lines 30A is still being scanned. In such an embodiment, the scanning of the plurality of first and second gate lines 30A, 30B may begin at different times, but overlap in duration.

In an embodiment, the controller 60 can scan the plurality of second gate lines 30B before beginning the scanning of the plurality of first gate lines 30A. For example, the controller 60 can begin scanning a first set (e.g., a subset) of the plurality of second gate lines 30B prior to scanning the plurality of first gate lines 30A. In an embodiment, the controller 60 can wait until the first set of the plurality of second gate lines 30B is completed or the controller 60 can begin scanning the plurality of first gate lines 30A while the plurality of second gate lines 30B is still being scanned. In such an embodiment, the scanning of the plurality of first and second gate lines 30A, 30B may begin at different times, but overlap in duration.

In an embodiment, the controller 60 can begin scanning the plurality of first gate lines 30A and the plurality of second gate lines 30B at about the same time (e.g., simultaneously). In such an embodiment, the scanning of the plurality of first gate lines 30A and the scanning of the plurality of second gate lines 30B occurs concurrently.

In an embodiment, the controller 60 can begin scanning the plurality of first gate lines 30A and the plurality of second gate lines 30B at about the same time (e.g., simultaneously). In such an embodiment, the scanning of the plurality of first gate lines 30A and the scanning of the plurality of second gate lines 30B occurs concurrently. In such an embodiment, a refresh rate at which the plurality of first gate lines 30A is scanned may be a higher refresh rate than the refresh rate at which the plurality of second gate lines 30B is scanned. For example, the refresh rate of the scanning of the plurality of first gate lines 30A may be at or about 120 Hz, at or about 180 Hz, at or about 240 Hz, or higher. Conversely, the refresh rate of the scanning of the plurality of second gate lines 30B may be at or about 60 Hz. It will be appreciated that these numbers are examples and that the actual refresh rate can vary beyond the stated values. In an embodiment, the refresh rate at which the plurality of first gate lines 30A is scanned may be double the refresh rate at which the plurality of second gate lines 30B is scanned. It will be appreciated that ratios other than double can still function according to the principles in this Specification.

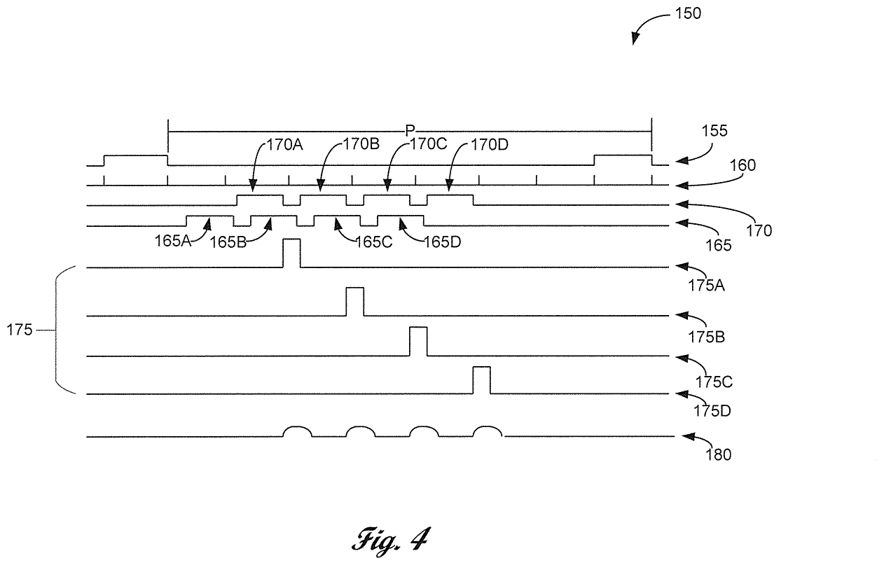

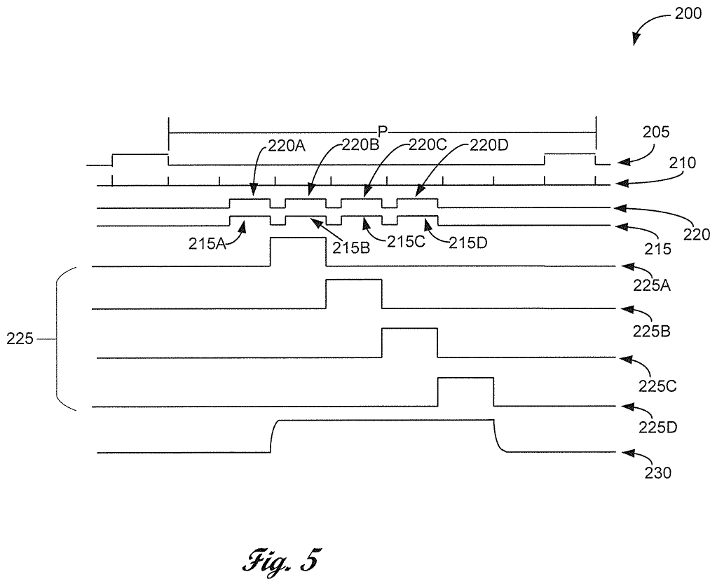

Embodiments of the method 100 illustrating the various scanning times are shown and described in accordance with FIGS. 4 and 5 below.

At 110, the controller 60 enables a drive signal to a first row 65A of a plurality of rows 65 of light sources of the backlight 55.

In an embodiment, the drive signal to the first row 65A of the plurality of rows 65 of light sources of the backlight 55 can be enabled based on different conditions. When enabling the drive signal to the first row 65A, the plurality of light sources in the first row 65A are illuminated.

In an embodiment, the drive signal to the first row 65A of the plurality of rows 65 of light sources of the backlight 55 can be enabled before completing scanning of a first set (e.g., a subset) of the plurality of first gate lines 30A. In an embodiment, the drive signal to the first row 65A of the plurality of rows 65 of light sources of the backlight 55 can be enabled in response to completing scanning of a first set (e.g., a subset) of the plurality of second gate lines.

In an embodiment, the drive signal to the first row 65A of the plurality of rows 65 of light sources of the backlight 55 can be illuminated before completing scanning of a first set (e.g., a subset) of the plurality of second gate lines 30A.

At 115, the controller 60 disables the drive signal to the first row 65A of the plurality of rows 65 of light sources of the backlight 55.

In an embodiment, disabling the drive signal to the first row 65A of the plurality of rows 65 of light sources of the backlight 55 can be based on different conditions. When disabling the drive signal to the first row 65A, the plurality of light sources in the first row 65A are turned off (e.g., not illuminated).

In an embodiment, the drive signal can be disabled before completing the scanning of a second set of the plurality of first gate lines 30A. In an embodiment, the drive signal can be disabled after completing the scanning of a second set of the plurality of second gate lines 30B.

The disabling of the drive signal occurs prior to scanning the second set of the plurality of first gate lines 30A and prior to the scanning of the second set of the plurality of second gate lines 30B. That is, the disabling of the first row 65A occurs before the controller 60 proceeds from scanning the first set of the plurality of first gate lines 30A and the first set of the plurality of second gate lines 30B to scanning the second set of the plurality of first gate lines 30A and the second set of the plurality of second gate lines 30B. As a result, the backlight will be selectively enabled and disabled rather than being continuously enabled, thereby saving energy, and reducing an amount of heat absorption.

Embodiments of the method 100 illustrating the various illumination times are shown and described in accordance with FIGS. 4 and 5 below.

FIG. 4 shows timing charts 150 of the method 100 of FIG. 3 for controlling the backlight (e.g., the backlight 55 in FIG. 2) in an LCD device (e.g., the LCD device 50 including the plurality of LCD panels (e.g., first LCD panel 10A and second LCD panel 10B in FIG. 2)), according to an embodiment.

The timing charts 150 show a vertical synchronization signal 155; a horizontal synchronization signal 160; a first LCD panel 10A scanning signal 165; a second LCD panel 10B scanning signal 170; backlight driving signals 175 (separated into first backlight driving signal 175A, second backlight driving signal 175B, third backlight driving signal 175C, and fourth backlight driving signal 175D); and a brightness intensity level 180 of the LCD device 50. It is to be appreciated that the timing charts 150 are schematic examples.

The vertical synchronization signal 155 defines a frame including a period P. Within the frame, the scanning signal 165 for the first LCD panel 10A is initiated in four pulses 165A-165D. It will be appreciated that the number of pulses 165A-165D is an example and can vary beyond the stated number. Also within the frame, the scanning signal 170 for the second LCD panel 10B is initiated in four pulses 170A-170D. It will be appreciated that the number of pulses 170A-170D is an example and can vary beyond the stated number. In an embodiment, a number of pulses 165A-165D and a number of pulses 170A-170D corresponds to a number of segments of the backlight driving signals 175. That is, when there are backlight signals 175A-175D, then the scanning signal 165 includes pulses 165A-165D and the scanning signal 170 includes pulses 170A-170D.

In the illustrated embodiment, the first scanning pulse 165A is representative of a beginning of scanning a first set of gate lines (e.g., gate lines 30A in FIG. 2). The scanning signal 170 for the second LCD panel 10B is initiated subsequent to the first scanning pulse 165. In the illustrated embodiment, once the first scanning pulse 165A is completed, a first scanning pulse 170A is initiated. The first scanning pulse 170A is representative of a beginning of scanning a first set of gate lines (e.g., gate lines 30B in FIG. 2) in the second LCD panel 10B.

In the illustrated embodiment, scanning the first set of the plurality of gate lines 30A begins prior to scanning the plurality of gate lines 30B. Specifically, scanning the first set of the plurality of gate lines 30B begins after the first set of the plurality of gate lines 30A is completed.

Once the first scanning pulse 170A is completed, the first backlight driving signal 175A is initiated. Duration of the first backlight driving signal 175A is such that the first backlight driving signal 175A is completed prior to a second scanning pulse 170B of the second LCD panel 10B. This process is repeated so that the second backlight driving signal 175B is enabled upon completion of the second scanning pulse 170B, the third backlight driving signal 175C is enabled upon completion of the third scanning pulse 170C, and the fourth backlight driving signal 175D is enabled upon completion of the fourth scanning pulse 170D.

The brightness level 180 is a visual representation of an intensity of the backlight 175 relative to the enabling/disabling of the backlight 175 via the different backlight driving signals 175A-175D. In the illustrated embodiment, the brightness level 180 increases while each backlight driving signal 175 is enabled.

FIG. 5 shows timing charts 200 of the method 100 of FIG. 3 for controlling the backlight (e.g., the backlight 55 in FIG. 2) in an LCD device (e.g., the LCD device 50 including the plurality of LCD panels (e.g., first LCD panel 10A and second LCD panel 10B in FIG. 2)), according to an embodiment.

The timing charts 200 show a vertical synchronization signal 205; a horizontal synchronization signal 210; a first LCD panel 10A scanning signal 215; a second LCD panel 10B scanning signal 220; backlight driving signals 225 (separated into first backlight driving signal 225A, second backlight driving signal 225B, third backlight driving signal 225C, and fourth backlight driving signal 225D); and a brightness level 230. It is to be appreciated that the timing charts 200 are schematic examples.

The vertical synchronization signal 205 defines a frame including a period P. Within the frame, the scanning signal 215 for the first LCD panel 10A is initiated in four pulses 215A-215D. It will be appreciated that the number of pulses 215A-215D is an example and can vary beyond the stated number. Also within the frame, the scanning signal 220 for the second LCD panel 10B is initiated in four pulses 220A-220D. It will be appreciated that the number of pulses 220A-220D is an example and can vary beyond the stated number. In an embodiment, a number of pulses 215A-215D and a number of pulses 220A-220D corresponds to a number of segments of the backlight driving signals 225. That is, when there are backlight signals 225A-225D, then the scanning signal 215 includes pulses 215A-215D and the scanning signal 220 includes pulses 220A-220D.

In the illustrated embodiment, the first scanning pulse 215A is representative of a beginning of scanning a first set of gate lines (e.g., gate lines 30A in FIG. 2). The scanning signal 220 for the second LCD panel 10B is initiated at about the same time as the scanning signal 215. The first scanning pulse 220A is representative of a beginning of scanning a first set of gate lines (e.g., gate lines 30B in FIG. 2) in the second LCD panel 10B.

In the illustrated embodiment, once the first scanning pulse 215A and the first scanning pulse 220A are completed, the first backlight driving signal 225A is initiated. Duration of the first backlight driving signal 225A is such that the first backlight driving signal 225A is completed at a same time as completion of a second scanning pulse 215B of the first LCD panel 10A and a second scanning pulse 220B of the second LCD panel 10B. At this time, the second backlight driving signal 225B is enabled. This process is repeated so that the third backlight driving signal 225C is enabled upon completion of the third scanning pulse 215C and the third scanning pulse 220C, and the fourth backlight driving signal 225D is enabled upon completion of the fourth scanning pulse 220D and the fourth scanning pulse 220D.

In the illustrated embodiment, the first backlight driving signal 225A is enabled to illuminate a first row of the backlight 55 until the scan of the second set of the plurality of gate lines 30A and the scan of the second set of the plurality of gate lines 30B is complete. Specifically, the first row of the plurality of rows of backlight 55 is disabled (e.g., first backlight driving signal 225A) before the second row of the plurality of rows of backlight 55 (e.g., second backlight driving signal 225B) illuminates.

The brightness level 230 is a visual representation of an intensity of the backlight 225 relative to the enabling/disabling of the backlight 55 via the different backlight driving signals 225A-225D. In the illustrated embodiment, the brightness level 230 increases when the first backlight driving signal 225A is enabled and decreases after the fourth backlight driving signal 225D is completed.

Aspects:

It is noted that any of aspects 1-9 below can be combined with any of aspects 10-15 or 16-20. Any of aspects 10-15 can be combined with any of aspects 16-20.

Aspect 1. A liquid crystal display device, comprising: a first liquid crystal display panel including a plurality of first gate lines; a second liquid crystal display panel including a plurality of second gate lines; a backlight arranged on a side of the first liquid crystal display panel such that the first liquid crystal display panel is adjacent the backlight and between the second liquid crystal display panel and the backlight, the backlight including a plurality of rows of light sources; a driving circuit configured to supply a drive signal to the plurality of rows of light sources; and a controller configured to: scan the plurality of first gate lines; scan the plurality of second gate lines; control the driving circuit to illuminate a first row of the plurality of rows of light sources after the scan of a first set of the plurality of first gate lines or after the scan of a first set of the plurality of second gate lines; and control the driving circuit to not illuminate the first row of the plurality of rows of light sources until the scan of a second set of the plurality of first gate lines is completed or the scan of a second set of the plurality of second gate lines is completed.

Aspect 2. The liquid crystal display device of aspect 1, wherein the controller is configured to scan the first set of the plurality of first gate lines prior to the scan of the first set of the plurality of second gate lines.

Aspect 3. The liquid crystal display device of one of aspects 1 or 2, wherein the controller is configured to scan the first set of the plurality of second gate lines in response to completing the scan of the first set of the plurality of first gate lines.

Aspect 4. The liquid crystal display device of any one of aspects 1-3, wherein the controller is configured to not illuminate the first row of the plurality of rows of light sources prior to at least one of the scan of the second set of the plurality of first gate lines and the scan of the second set of the plurality of second gate lines.

Aspect 5. The liquid crystal display device of any one of aspects 1-4, wherein the controller is configured to illuminate the first row of the plurality of rows of light sources until the scan of the second set of the plurality of first gate lines and the scan of the second set of the plurality of second gate lines is complete.

Aspect 6. The liquid crystal display device of any one of aspects 1-5, wherein the controller is configured to not illuminate the first row of the plurality of rows of light sources before the controller illuminates a second row of the plurality of rows of light sources.

Aspect 7. The liquid crystal display device of any one of aspects 1-6, wherein a refresh rate of the first liquid crystal display panel is higher than a refresh rate of the second liquid crystal display panel.

Aspect 8. The liquid crystal display device of aspect 7, wherein the refresh rate of the first liquid crystal display panel is double the refresh rate of the second liquid crystal display panel.

Aspect 9. The liquid crystal display device of any one of aspects 1-8, wherein a refresh rate of the second liquid crystal display panel is higher than a refresh rate of the first liquid crystal display panel.

Aspect 10. A method of illuminating a liquid crystal display device including a first liquid crystal display panel, a second liquid crystal display panel, and a backlight, the method comprising: scanning, with a controller, a plurality of first gate lines, the plurality of first gate lines corresponding to the first liquid crystal display panel; scanning, with the controller, a plurality of second gate lines, the plurality of second gate lines corresponding to the second liquid crystal display panel; enabling a drive signal to a first row of a plurality of rows of light sources of the backlight before completing scanning of a first set of the plurality of first gate lines or in response to completing scanning of a first set of the plurality of second gate lines; and disabling the drive signal to the first row of the plurality of rows of light sources of the backlight before completing scanning of a second set of the plurality of first gate lines or completing scanning of a second set of the plurality of second gate lines.

Aspect 11. The method of aspect 10, wherein the scanning the plurality of first gate lines is performed prior to the scanning of the plurality of second gate lines.

Aspect 12. The method of one of aspects 10 or 11, wherein the scanning the plurality of second gate lines is performed subsequent to completing scanning of the first set of the plurality of first gate lines.

Aspect 13. The method of any one of aspects 10-12, wherein disabling the drive signal to the first row of the plurality of light sources of the backlight is performed prior to the scanning of the second set of the plurality of first gate lines and the scanning of the second set of the plurality of second gate lines.

Aspect 14. The method of any one of aspects 10-13, wherein enabling the drive signal to the first row of the plurality of rows of light sources of the backlight is performed after scanning the second set of the plurality of first gate lines and scanning the second set of the plurality of second gate lines.

Aspect 15. The method of any one of aspects 10-14, wherein disabling the drive signal to the first row of the plurality of light sources of the backlight is performed before enabling a second row of the plurality of light sources of the backlight.

Aspect 16. A scanning backlight system for a liquid crystal display device including a first liquid crystal display panel including a plurality of first gate lines; a second liquid crystal display panel including a plurality of second gate lines; and a backlight arranged on a side of the first liquid crystal display panel such that the first liquid crystal display panel is adjacent the backlight and between the second liquid crystal display panel and the backlight, the backlight including a plurality of rows of light sources; the scanning backlight system comprising: a driving circuit configured to supply a drive signal to the plurality of rows of light sources; and a controller configured to: scan the plurality of first gate lines; scan the plurality of second gate lines; control the driving circuit to illuminate a first row of the plurality of rows of light sources after the scan of a first set of the plurality of first gate lines or after the scan of a first set of the second plurality of second gate lines; and control the driving circuit to not illuminate the first row of the plurality of rows of light sources until the scan of a second set of the plurality of first gate lines is completed or the scan of a second set of the second plurality of second gate lines is completed.

Aspect 17. The scanning backlight system of aspect 16, wherein the controller is configured to scan the first set of the plurality of first gate lines prior to the scan of the first set of the plurality of second gate lines.

Aspect 18. The scanning backlight system of one of aspects 16 or 17, wherein the controller is configured to scan the first set of the second plurality of second gate lines in response to completing the scan of the first set of the plurality of first gate lines.

Aspect 19. The scanning backlight system of any one of aspects 16-18, wherein the controller is configured to not illuminate the first row of the plurality of rows of light sources prior to the scan of the second set of the plurality of first gate lines and the scan of the second set of the plurality of second gate lines.

Aspect 20. The scanning backlight system of any one of aspects 16-19, wherein the controller is configured to illuminate the first row of the plurality of rows of light sources until the scan of the second set of the plurality of first gate lines and the scan of the second set of the plurality of second gate lines is complete.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

1. A liquid crystal display device, comprising:
a first liquid crystal display panel including a plurality of first gate lines;
a second liquid crystal display panel including a plurality of second gate lines;
a backlight arranged on a side of the first liquid crystal display panel such that the first liquid crystal display panel is adjacent the backlight and between the second liquid crystal display panel and the backlight, the backlight including a plurality of rows of light sources;
a driving circuit configured to supply a drive signal to the plurality of rows of light sources; and
a controller configured to:
scan the plurality of first gate lines;
scan the plurality of second gate lines;
control the driving circuit to illuminate a first row of the plurality of rows of light sources after the scan of a first set of the plurality of first gate lines or after the scan of a first set of the plurality of second gate lines,
wherein the scan of the first set of the plurality of first gate lines is executed prior to the scan of the first set of the plurality of second gate lines, and
wherein a refresh rate of the first liquid crystal display panel is the same as a refresh rate of the second liquid crystal display panel; and
control the driving circuit to not illuminate the first row of the plurality of rows of light sources until the scan of a second set of the plurality of first gate lines is completed or the scan of a second set of the plurality of second gate lines is completed.

2. (canceled)

3. The liquid crystal display device of claim 1, wherein the controller is configured to scan the first set of the plurality of second gate lines in response to completing the scan of the first set of the plurality of first gate lines.

4. The liquid crystal display device of claim 1, wherein the controller is configured to not illuminate the first row of the plurality of rows of light sources prior to at least one of the scan of the second set of the plurality of first gate lines and the scan of the second set of the plurality of second gate lines.

5. The liquid crystal display device of claim 1, wherein the controller is configured to illuminate the first row of the plurality of rows of light sources until the scan of the second set of the plurality of first gate lines and the scan of the second set of the plurality of second gate lines is complete.

6. The liquid crystal display device of claim 1, wherein the controller is configured to not illuminate the first row of the plurality of rows of light sources before the controller illuminates a second row of the plurality of rows of light sources.

7-9. (canceled)

10. A method of illuminating a liquid crystal display device including a first liquid crystal display panel, a second liquid crystal display panel, and a backlight, the method comprising:
scanning, with a controller, a plurality of first gate lines, the plurality of first gate lines corresponding to the first liquid crystal display panel;
scanning, with the controller, a plurality of second gate lines, the plurality of second gate lines corresponding to the second liquid crystal display panel;
enabling a drive signal to a first row of a plurality of rows of light sources of the backlight before completing scanning of a first set of the plurality of first gate lines or in response to completing scanning of a first set of the plurality of second gate lines,
wherein the scanning of the first set of the plurality of first gate lines is executed prior to the scanning of the first set of the plurality of second gate lines, and
wherein a refresh rate of the first liquid crystal display panel is the same as a refresh rate of the second liquid crystal display panel; and
disabling the drive signal to the first row of the plurality of rows of light sources of the backlight before completing scanning of a second set of the plurality of first gate lines or completing scanning of a second set of the plurality of second gate lines.

11. (canceled)

12. The method of claim 10, wherein the scanning the plurality of second gate lines is performed subsequent to completing scanning of the first set of the plurality of first gate lines.

13. The method of claim 10, wherein disabling the drive signal to the first row of the plurality of light sources of the backlight is performed prior to the scanning of the second set of the plurality of first gate lines and the scanning of the second set of the plurality of second gate lines.

14. The method of claim 10, wherein enabling the drive signal to the first row of the plurality of rows of light sources of the backlight is performed after scanning the second set of the plurality of first gate lines and scanning the second set of the plurality of second gate lines.

15. The method of claim 10, wherein disabling the drive signal to the first row of the plurality of light sources of the backlight is performed before enabling a second row of the plurality of light sources of the backlight.

16. A scanning backlight system for a liquid crystal display device including a first liquid crystal display panel including a plurality of first gate lines; a second liquid crystal display panel including a plurality of second gate lines; and a backlight arranged on a side of the first liquid crystal display panel such that the first liquid crystal display panel is adjacent the backlight and between the second liquid crystal display panel and the backlight, the backlight including a plurality of rows of light sources; the scanning backlight system comprising:
a driving circuit configured to supply a drive signal to the plurality of rows of light sources; and
a controller configured to:
scan the plurality of first gate lines;
scan the plurality of second gate lines;
control the driving circuit to illuminate a first row of the plurality of rows of light sources after the scan of a first set of the plurality of first gate lines or after the scan of a first set of the plurality of second gate lines
wherein the scan of the first set of the plurality of first gate lines is executed prior to the scan of the first set of the plurality of second gate lines, and
wherein a refresh rate of the first liquid crystal display panel is the same as a refresh rate of the second liquid crystal display panel; and
control the driving circuit to not illuminate the first row of the plurality of rows of light sources until the scan of a second set of the plurality of first gate lines is completed or the scan of a second set of the plurality of second gate lines is completed.

17. (canceled)

18. The scanning backlight system of claim 16, wherein the controller is configured to scan the first set of the second plurality of second gate lines in response to completing the scan of the first set of the plurality of first gate lines.

19. The scanning backlight system of claim 16, wherein the controller is configured to not illuminate the first row of the plurality of rows of light sources prior to the scan of the second set of the plurality of first gate lines and the scan of the second set of the plurality of second gate lines.

20. The scanning backlight system of claim 16, wherein the controller is configured to illuminate the first row of the plurality of rows of light sources until the scan of the second set of the plurality of first gate lines and the scan of the second set of the plurality of second gate lines is complete.
